(19) United States
(12) Patent Application Publication
(10) Pub. No.: US 2006/0114206 A1
(43) Pub. Date: Jun. 1, 2006

(54) Method and apparatus for modulating video data and liquid crystal display using the same

(75) Inventor: Sung Jo Koo, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD.

(21) Appl. No.: 11/149,165

(22) Filed: Jun. 10, 2005

(30) Foreign Application Priority Data
Nov. 11, 2004 (KR) P2004-092131

(51) Int. Cl. G09G 3/36

(52) U.S. Cl. 345/88

(57) ABSTRACT

A method of modulating a video data includes extracting a luminance signal and a color difference signal from the video data, modulating the luminance signal to generate a modulated luminance signal, and modulating the video data by using the modulated luminance signal and the color difference signal as an un-modulating data.

This application claims the benefit of the Korean Patent Application No. P2004-092131 filed on Nov. 11, 2004, which is hereby incorporated by reference.

### BACKGROUND OF THE INVENTION

1. Field of the Invention

The present invention relates to a method and apparatus for modulating video data, and more particularly, to a method and apparatus that modulate video data of a liquid crystal display (LCD) device to increase display quality and reduce memory capacity.

2. Background for the Related Art

An LCD device controls the light transmissivity of liquid crystal cells in accordance with a video signal, thereby displaying a picture. There is an active matrix type of LCD device having a switching device formed at each liquid crystal cell. The active matrix type of LCD device has an advantage in realizing a motion picture because an active control of the switching device is possible. A thin film transistor (TFT) is mainly used as the switching device in the active matrix type of LCD device.

The LCD, as shown in Mathematical Formulas 1 and 2, has a disadvantage in that in response speed is slow because of characteristics of the unique viscosity and elasticity of liquid crystal.

$${τ}_{r} ∝ \frac{γ {d}^{2}}{Δɛ \vert {V}_{a}^{2} - {V}_{F}^{2} \vert} \qquad [ MATHEMATICAL FORMULA 1 ]$$

Herein, τᵣ represents a rising time when a voltage is applied to liquid crystal, Va represents an applied voltage, V_{F} represents a Freederick Transition Voltage where a liquid crystal molecule starts a tilt motion, d represents a cell gap of a liquid crystal cell, and γ (gamma) represents the rotational viscosity of the liquid crystal molecule.

$${τ}_{f} ∝ \frac{γ {d}^{2}}{K} \qquad [ MATHEMATICAL FORMULA 2 ]$$

Herein, τ_{f} represents a falling time when the liquid crystal is restored to its original location by its elastic restitutive force after the voltage applied to the liquid crystal is off, and K represents the unique elastic modulus of liquid crystal.

The response speed of the liquid crystal of twisted nematic TN mode that is most generally used might be different in accordance with the physical property and cell gap of a liquid crystal material, but conventionally, the rising time is 20˜80 ms and the falling time is 20˜30 ms. The response speed of the liquid crystal is longer than one frame period (NTSC: 16.67 ms). Because of this, the liquid crystal progresses to the next frame before the voltage charged in the liquid crystal cell reaches a desired voltage, as shown in FIG. 1. The result is a motion blurring phenomenon, which blurs with a motion picture.

Referring to FIG. 1, an LCD device of the related art cannot express a desired color and brightness because display brightness BL corresponding thereto does not reach a desired brightness MBL when a data VD is changed from one level to another level. As a result, the LCD device has the motion blurring phenomenon, and its picture quality drops due to the deterioration of contrast ratio.

In order to solve the slow response speed of the LCD device, U.S. Pat. No. 5,495,265 or PCT International Publication No. WO99/05567 proposed a method of modulating a data in accordance with the existence or absence of the change of the data using a look-up table (hereinafter referred to as “high-speed driving method”). The high speed driving method modulates the data with the same principle as FIG. 2.

Referring to FIG. 2, the high speed driving method modulates an input data VD into a pre-set modulated data MVD, and the modulated data MVD is applied to the liquid crystal cell to get the desired brightness MBL. The high speed driving method has the value of |Vₒ²−V_{F}²| in Mathematical Formula I on the basis of the existence or absence of change of the data in order to get a desired brightness corresponding to the brightness value of the input data within one frame period. Accordingly, the LCD device using the high speed driving method compensates the slow response time of liquid crystal by modulating the data value to ease the motion blurring phenomenon. In other words, the high speed driving method modulates the data of the current frame to a pre-set modulated data if there is any change in the data when the data are compared between the previous frame and the current frame. The high speed driving apparatus that utilizes the high speed driving method is shown in FIG. 3.

Referring to FIG. 3, the high speed driving apparatus includes first and second frame memories 33a and 33b to store the data from a data bus 32, and a look-up table 34 to modulate the data. The first and second frame memories 33a and 33b alternately store the data by the frame in accordance with a pixel clock, alternately output the stored data, and supply the previous frame data, i.e., (n−1)^{th} frame data (Fn−1), to the look-up table 34.

The look-up table 34 compares the n^{th} frame data (Fn) from the data input bus 32 and the (n−1)^{th} frame data (Fn−1) from the first and second frame memories 33a and 33b to generate a comparison result, and selects a modulated data MRGB corresponding to the comparison result, as in Table 1. The modulated data MRGB is stored at a read only memory ROM in the look-up table 34.

TABLE 1

| | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| 0 | 0 | 2 | 3 | 4 | 5 | 6 | 7 | 9 | 10 | 12 | 13 | 14 | 15 | 15 | 15 | 15 |
| 1 | 0 | 1 | 3 | 4 | 5 | 6 | 7 | 8 | 10 | 12 | 13 | 14 | 15 | 15 | 15 | 15 |
| 2 | 0 | 0 | 2 | 4 | 5 | 6 | 7 | 8 | 10 | 12 | 13 | 14 | 15 | 15 | 15 | 15 |
| 3 | 0 | 0 | 1 | 3 | 5 | 6 | 7 | 8 | 10 | 11 | 13 | 14 | 15 | 15 | 15 | 15 |
| 4 | 0 | 0 | 1 | 3 | 4 | 6 | 7 | 8 | 9 | 11 | 12 | 13 | 14 | 15 | 15 | 15 |
| 5 | 0 | 0 | 1 | 2 | 3 | 5 | 7 | 8 | 9 | 11 | 12 | 13 | 14 | 15 | 15 | 15 |
| 6 | 0 | 0 | 1 | 2 | 3 | 4 | 6 | 8 | 9 | 10 | 12 | 13 | 14 | 15 | 15 | 15 |
| 7 | 0 | 0 | 1 | 2 | 3 | 4 | 5 | 7 | 9 | 10 | 11 | 13 | 14 | 15 | 15 | 15 |
| 8 | 0 | 0 | 1 | 2 | 3 | 4 | 5 | 6 | 8 | 10 | 11 | 12 | 14 | 15 | 15 | 15 |
| 9 | 0 | 0 | 1 | 2 | 3 | 4 | 5 | 6 | 7 | 9 | 11 | 12 | 13 | 14 | 15 | 15 |
| 10 | 0 | 0 | 1 | 2 | 3 | 4 | 5 | 6 | 7 | 8 | 10 | 12 | 13 | 14 | 15 | 15 |
| 11 | 0 | 0 | 1 | 2 | 3 | 4 | 5 | 6 | 7 | 8 | 9 | 11 | 13 | 14 | 15 | 15 |
| 12 | 0 | 0 | 1 | 2 | 3 | 4 | 5 | 6 | 7 | 8 | 9 | 10 | 12 | 14 | 15 | 15 |
| 13 | 0 | 0 | 1 | 2 | 3 | 3 | 4 | 5 | 6 | 7 | 8 | 10 | 11 | 13 | 15 | 15 |
| 14 | 0 | 0 | 1 | 2 | 3 | 3 | 4 | 5 | 6 | 7 | 8 | 9 | 11 | 12 | 14 | 15 |
| 15 | 0 | 0 | 0 | 1 | 2 | 3 | 3 | 4 | 5 | 6 | 7 | 8 | 9 | 11 | 13 | 15 |

In the Table 1, the leftmost column represents the data of the previous frame Fn−1 and the uppermost row represents the data of the current frame Fn.

For the n^{th} frame period, the nth frame data (Fn) is stored at the first frame memory and supplied to the look-up table 34 in accordance with the same pixel clock as shown in solid line. At the same time, the second frame memory 33b supplies the (n−1)th frame data (Fn−1) to the look-up table 34. Differently from this, for the (n+1)^{th} frame period, the current (n+₁)^{th} frame data (Fn+1) is stored at the second frame memory 33b and simultaneously supplied to the look-up table 34 in accordance with the same pixel clock as shown in dot line. At the same time, for the (n+1)^{th} frame period, the first frame memory 33a supplies the n^{th} frame data (Fn) to the look-up table 34. In this way, the high speed driving apparatus needs two frame memories 33a and 33b in order to alternately supply the previous frame data. The frame memory increases a circuit cost. Thus a method for reducing the number of the frame memories and reducing the capacity is required.

On the other hand, a method of compressing the data and storing the data at the frame memory by using a data compression method can be taken into consideration, but there is a problem because an error might be generated in the restored data due to the compression loss following quantization. Further, there is a further problem that a data compression circuit becomes complicated in order to realize the compression and restoration algorithm. For example, if the compression and restoration algorithm of the data uses a block truncation coding BTC, the circuit needs to include a compressor, a restorer, an adder and a subtracter inclusive of a quantization.

### SUMMARY OF THE INVENTION

Accordingly, the present invention is directed to a method and apparatus that substantially obviates one or more of the problems due to limitations and disadvantages of the related art.

An object of the present invention is to provide a method and apparatus of modulating a video data to reduce compression loss.

Another object of the present invention is to provide an LCD device that uses the modulating method and apparatus to modulate the video data to increase its display quality and reduce its memory capacity.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of modulating a video data according to an aspect of the present invention includes the steps of: extracting a luminance signal and a color difference signal from the video data; modulating the luminance signal into a modulated luminance signal; and modulating the video data by using the color difference signal, which serves as un-modulated data, and the modulated luminance signal.

An apparatus of modulating a video data according to another aspect of the present invention includes a brightness & color difference separator to extract a luminance signal and a color difference signal from the video data; a first modulator to modulate the luminance signal to generate a modulated luminance signal; and a second modulator to modulate the video data by using the modulated luminance signal and the color signal that serves as un-modulated data

A liquid crystal display (LCD) device according to still another aspect of the present invention includes an LCD panel; a brightness & color difference separator to extract a luminance signal and a color difference signal from a video data; a first modulator to modulate the luminance signal to generate a modulated luminance signal; a second modulator to modulate the video data to generate a modulated video data by using the modulated luminance signal and the color signal that serves as un-modulated data; and a driver to display the modulated video data to the LCD panel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention. In the drawings:

FIG. 1 is a waveform diagram representing a brightness change in accordance with data in an LCD device of the related art.

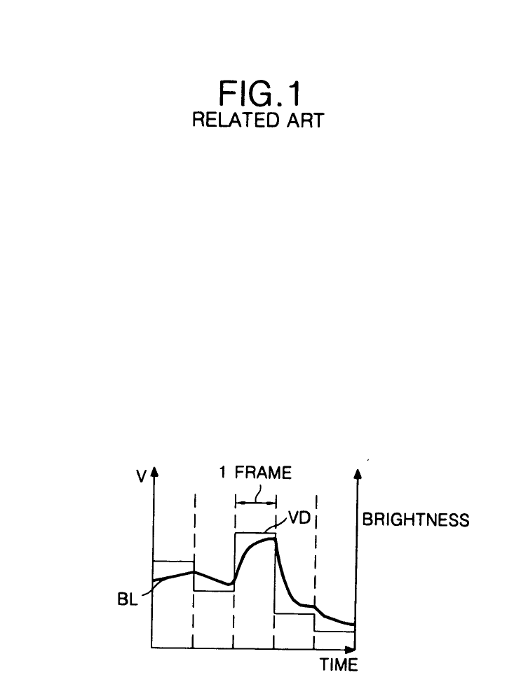

FIG. 2 is a waveform diagram representing an example of the brightness change in accordance with data modulation in a high speed driving method of the related art.

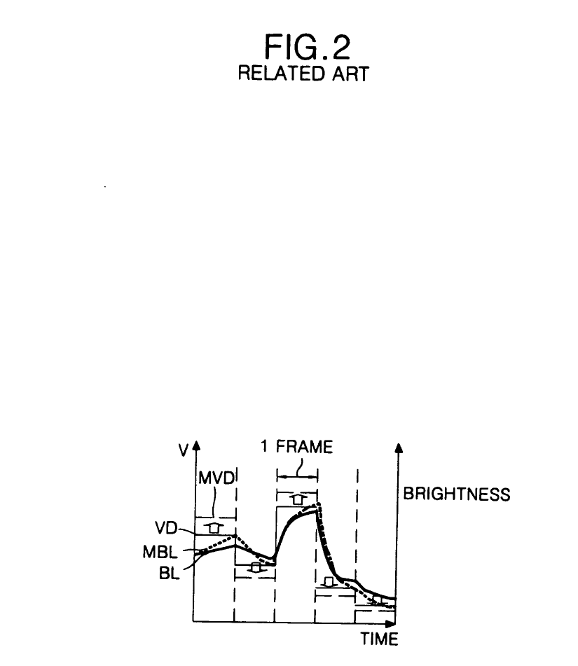

FIG. 3 is a diagram representing one example of the high speed driving method of the related art.

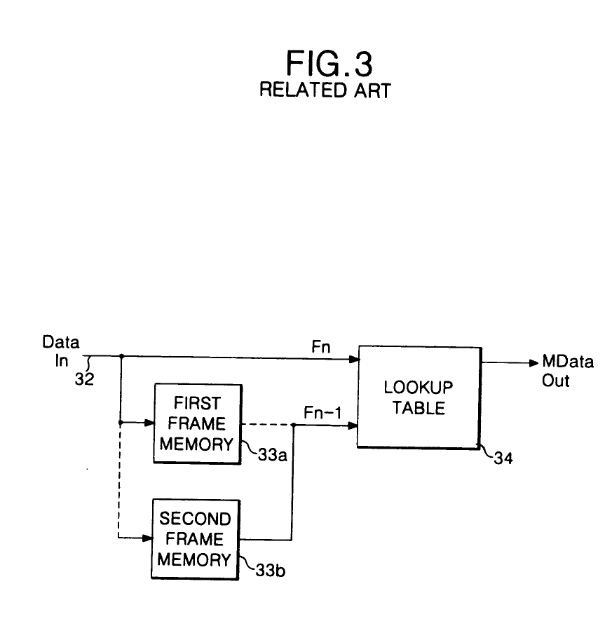

FIG. 4 is a diagram representing an LCD device in accordance with an embodiment of the present invention.

FIG. 5 is a detailed diagram representing a modulator as shown in FIG. 4.

### DETAILED DESCRIPTION OF THE PREFERRED EMBODIMENTS

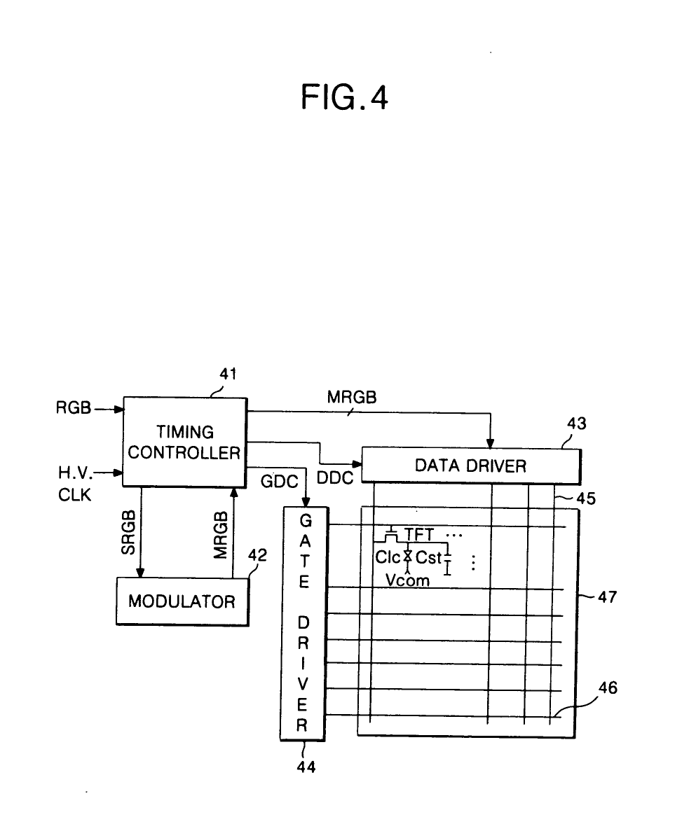

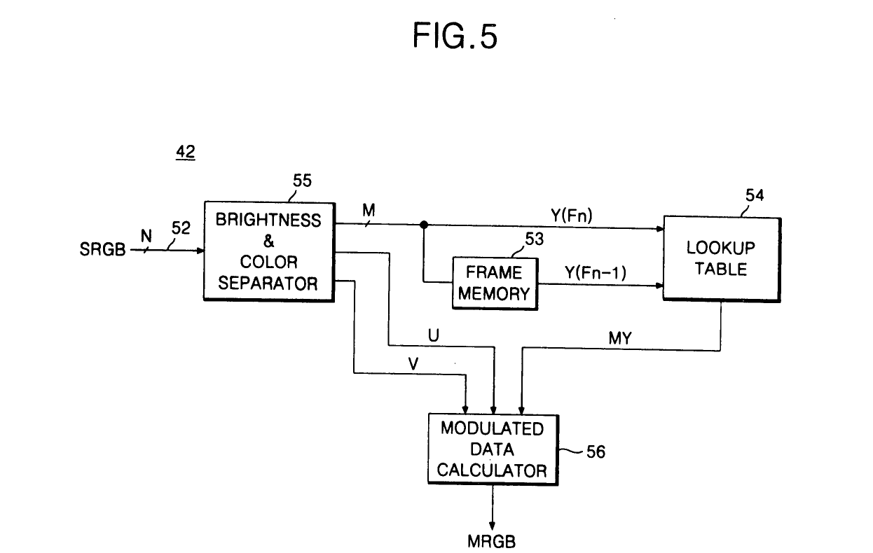

Reference will now be made in detail to the preferred embodiments of the present invention, examples of which are illustrated in the accompanying drawings. Hereinafter, the preferred embodiments of the present invention will be described in detail with reference to FIGS. 4 and 5.

Referring to FIG. 4, an LCD device according to an exemplary embodiment of the present invention includes an LCD panel 47 where a thin film transistor TFT is formed to drive a liquid crystal cell Clc at an intersection of a data line 45 and a gate line 46, a modulator 42 to modulate data by using a modulated luminance signal, a data driver 43 to supply modulated data MRGB to the data line 45 of the LCD panel 47, a gate driver 44 to supply a scan pulse to the gate line 46 of the LCD panel 47, and a timing controller 41 to control the data driver 43 and the gate driver 44 and to supply source data SRGB to the modulator 42.

The LCD panel 47 has a liquid crystal injected between two glass substrates, and the data lines 45 and the gate lines 46 perpendicularly cross each other on [[the]] a lower glass substrate. The TFT formed at the intersection of the data lines 45 and the gate lines 46 supplies the data from the data lines 45 to the liquid crystal cell Clc in response to a scan pulse from the gate line 46. For this, the TFT has a gate electrode connected to the gate line 46, a source electrode connected to the data line 45, and a drain electrode connected to a pixel electrode of the liquid crystal cell Clc. Further, a storage capacitor Cst is formed on the lower glass substrate of the LCD panel 47 to maintain the voltage of the liquid crystal cell Clc. The storage capacitor Cst might be formed between the liquid crystal cell Clc and the previous stage gate line 46, or between the liquid crystal cell Clc and a separate common line.

Referring to FIG. 5, the modulator 42 extracts a luminance signal Y and color difference signals U, V from the source data SRGB, which is from the timing controller 41, and modulates the luminance signal Y based on the change of the source data SRGB between the previous frame and the current frame, and modulates the source data SRGB by using the modulated luminance signal MY. The modulated data MRGB outputted from the modulator 42 in fact satisfies the condition of Mathematical Formulas 3 to 5.
Fn(SRGB)<Fn−1(SRGB)−−−>Fn(MRGB)<Fn(SRGB) [MATHEMATICAL FORMULA 3]
Fn(SRGB)=Fn−1(SRGB)−−−>Fn(MRGB)=Fn(SRGB) [MATHEMATICAL FORMULA 4]
Fn(SRGB)>Fn−1(SRGB)−−−>Fn(MRGB)>Fn(SRGB) [MATHEMATICAL FORMULA 5]

The Mathematical Formula 3 denotes that the modulated data MRGB is smaller than the source data of the current frame Fn if the data value of a pixel becomes smaller than the current frame Fn as in the previous frame (Fn−1). The Mathematical Formula 4 denotes that the modulated data MRGB in fact has the same value as the source data of the current frame Fn if the pixel data value is the same in the current frame Fn as in the previous frame (Fn−1). The Mathematical Formula 5 denotes that the modulated MRGB is bigger than the source data of the current frame Fn if the data value of a pixel becomes bigger in the current frame Fn than in the previous frame (Fn−1) in the same pixel.

Referring back to FIG. 4, the timing controller 41 generates a gate control signal GDC for controlling the gate driver 44, a data control signal DDC for controlling the data driver 43, and a control signal for controlling the modulator 42 by using vertical/horizontal synchronizing signal V, H and a pixel clock CLK. The timing controller 41 samples a digital video data RGB in accordance with the pixel clock CLK, and supplies the data RGB to the modulator 42 as the source data SRGB and the modulated data MRGB from the modulator 42 to the data driver 43.

The data driver 43 includes a shift register, a register to temporarily store the modulated data MRGB from the timing controller 41, a latch to store the data by the line and to simultaneously output the stored data of one line in response to the clock signal from the shift register, a digital/analog converter to select an analog positive/negative gamma compensation voltage in correspondence to the digital data value from the latch, a multiplexer to select the data line 45 to which the positive/negative gamma compensation voltage is supplied, and an output buffer connected between the multiplexer and the data line 45. The data driver 43 receives and supplies the modulated data MRGB to the data lines 45 of the LCD panel 47 under the control of the timing controller 41.

The gate driver 44 includes a shift register to sequentially generate a scan pulse in response to the gate control signal GDC from the timing controller 41, a level shifter to shift the swing width of the scan pulse to an adequate level for driving the liquid crystal cell Clc, and an output buffer. The gate driver 44 supplies the scan pulse to the gate line 46 to turn on the TFT's connected to the gate line 46, thereby selecting the liquid crystal cells Clc of one horizontal line to which the pixel voltage of the data, i.e., the analog gamma compensation voltage, is to be supplied. The data generated from the data driver 43 are synchronized with the scan pulse, thereby being supplied to the liquid crystal cells Clc of a selected one horizontal line.

FIG. 4 shows an exemplary embodiment in which the timing controller 41 and the modulator 42 can be integrated into one chip.

FIG. 5 is a diagram representing the modulator 42 in detail. Referring to FIG. 5, the modulator 42 according to an exemplary embodiment of the present invention includes a brightness & color difference separator 55, a frame memory 53, a look-up table 54, and a modulated data calculator 56.

The brightness & color difference separator 55 receives the source data SRGB of N bits (N is an integer) from the timing controller 41 (of FIG. 4) through a data bus 52, and outputs the luminance signal Y of M bits (M is an integer that is smaller than N) and the color difference signals U, V. In order to express 256 gray levels, if each of the red R, green G and blue B source data SRGB has a data length of 8 bits, N is 24 and M is 8. Assuming such a source data SRGB of 256 gray levels, the brightness & color difference separator 55 extracts the color difference signals U, V and the luminance signal Y from the source data SRGB by using the following Mathematical Formulas 6 to 8.
Y=(77R+150G+29B)/256 [MATHEMATICAL FORMULA 6]
U=(43R−85G+128B+32768)/256 [MATHEMATICAL FORMULA 7]
V=(128R−107G+121B+32768)/256 [MATHEMATICAL FORMULA 8]

In the Mathematical Formulas 6 to 8, R is a red data value, G is a green data value and B is a blue data value.

The frame memory 53 receives the luminance signal Y(Fn) of M bits to store the luminance signal Y(Fn) for one frame period, and then supplies it to the look-up table 54. That is, the frame memory 53 serves to delay the luminance signal Y(Fn).

The look-up table 54 selects a pre-stored modulated brightness data MY by having the luminance signal Y(Fn) of n^{th} frame Fn inputted from the brightness & color difference separator 55 and the luminance signal Y(Fn−1) of (n−1)^{th} frame (Fn−1) inputted from the frame memory 53 as an address, to modulate the brightness component of the source data SRGB. The modulated brightness data MY stored at the look-up table 54 are pre-set by gray levels for the modulated data MRGB to satisfy the mathematical formulas 4 and 5 and are stored at the frame memory 53.

The modulated data calculator 56 calculates the modulated data MRGB by using the color difference signal UV inputted from the brightness & color difference separator 55 and the modulated brightness data MY inputted from the look-up table 54. Assuming 256 gray levels, the modulated data calculator 56 calculates the modulated data MRGB by using the following mathematical formulas 9 to 11.
R′=(256Y+358V45824)/256 [MATHEMATICAL FORMULA 9]
G′=(256Y−88U+184V+34186)/256 [MATHEMATICAL FORMULA 10]
B′=(256Y+454U−58112)/256 [MATHEMATICAL FORMULA 11]

In the mathematical formulas 9 to 11, R′ is a modulated red data value, G′ is a modulated green data value and B′ is a modulated blue data value.

As a result, the method and apparatus of modulating the video data according to the exemplary embodiment of the present invention extracts only the brightness component of a low data length, which sensitively reacts to a naked eye, from the video data and modulates the data by using the brightness component so that there is a data compression effect, and there is no compression loss because there is no quantization process. Further, the LCD device according to the exemplary embodiment of the present invention makes the response speed of the liquid crystal faster by modulating the video data without the compression loss by using the brightness modulation, thereby increasing the display quality in the motion picture.

As described above, the method and apparatus of modulating the video data according to the present invention can modulate the video data without the compression loss by modulating only the brightness component. Further, the LCD device according to the present invention can increase the display quality by using the method and apparatus of modulating the video data.

It will be apparent to those skilled in the art that various modifications and variations can be made in the modulating method and apparatus of the present invention without departing from the spirit or scope of the inventions. Thus, it is intended that the present invention cover the modifications and variations of this invention provided they come within the scope of the appended claims and their equivalents.

What is claimed is:

1. A method of modulating a video data, comprising:
extracting a luminance signal and a color difference signal from the video data;
modulating the luminance signal into a modulated luminance signal; and
modulating the video data by using the color difference signal as un-modulated data and the modulated luminance signal.

2. The method according to claim 1, wherein modulating the luminance signal includes:
delaying the luminance signal to generate a delayed luminance signal;
comparing the luminance signal with the delayed luminance signal to generate a comparison result; and
selecting one of pre-set modulated brightness data in accordance with the comparison result.

3. The method according to claim 2, wherein modulating the video data includes:
calculating red, green and blue video data respectively by using the selected one of modulated brightness data and the un-modulated data.

4. An apparatus of modulating a video data, comprising:
a brightness & color difference separator to extract a luminance signal and a color difference signal from the video data;
a first modulator to modulate the luminance signal to generate a modulated luminance signal; and
a second modulator to modulate the video data by using the modulated luminance signal and the color difference signal as un-modulated data.

5. The apparatus according to claim 4, wherein the first modulator includes:
a memory to delay the luminance signal to generate a delayed luminance signal; and
a look-up table including pre-set modulated brightness data, wherein the look-up table compares the luminance signal with the delayed luminance signal to generate a comparison result, selects one of the pre-set modulated brightness data in accordance with the comparison result, and sends the selected one of the pre-set modulated brightness data to the second modulator.

6. The apparatus according to claim 4, wherein the second modulator calculates red, green and blue video data respectively by using the selected modulated brightness data and the tin-modulated data.

7. A liquid crystal display (LCD) device, comprising:
an LCD panel;
a brightness & color difference separator to extract a luminance signal and a color difference signal from a video data;
a first modulator to modulate the luminance signal to generate a modulated luminance signal;
a second modulator to modulate the video data to generate a modulated video data by using the modulated luminance signal and the color difference signal as un-modulated data; and
a driver to display the modulated video data on the LCD panel.

8. The LCD device according to claim 7, wherein the first modulator includes:
a memory to delay the luminance signal to generate a delayed luminance signal; and
a look-up table including pre-set modulated brightness data, wherein the look-up table compares the luminance signal with the delayed luminance signal to generate a comparison result, selects at least one modulated brightness data from the pre-set modulated brightness data in accordance with the comparison result, and sends the selected modulated brightness data to the second modulator.

9. The LCD device according to claim 7, wherein the second modulator calculates red, green and blue video data respectively by using the selected the modulated brightness data and the un-modulated data.

10. The LCD device according to claim 7, wherein the driver includes:
a data driver to convert the modulated video data into an analog pixel voltage and to supply the analog pixel voltage to the LCD panel;
a gate driver to supply a scan signal to the LCD panel; and
a timing controller to supply the un-modulated video data to the first modulator and the modulated video data to the data driver and to control the data driver and the gate driver.

11. A method for modulating a video data of a liquid crystal display (LCD) device, comprising:
extracting a luminance signal and a color difference signal from a video data;
modulating the luminance signal to generate a modulated luminance signal;
modulating the video data to generate a modulated video data by using the modulated luminance signal and the color difference signal as un-modulated data; and
displaying the modulated video data on an LCD panel.

12. The method according to claim 11, wherein modulating the luminance signal includes:
delaying the luminance signal to generate a delayed luminance signal; and
comparing the luminance signal with the delayed luminance signal to generate a comparison result,
selecting at least one modulated brightness data from the pre-set modulated brightness data in accordance with the comparison result, and
outputting the selected modulated brightness data for modulating the video data.

13. The method according to claim 11, wherein modulating the video data include calculating red, green and blue video data respectively by using the selected the modulated brightness data and the un-modulated data.

14. The method according to claim 11, wherein displaying the modulated video data includes:
converting the modulated video data into an analog pixel voltage;
supplying the analog pixel voltage to the LCD panel; and
supplying a scan signal to the LCD panel.
